(19) United States
(12) Patent Application Publication
(10) Pub. No.: US 2024/0422417 A1
(43) Pub. Date: Dec. 19, 2024

(54) ILLUMINATION DEVICE FOR ILLUMINATING A SCENE, CAMERA SYSTEM AND METHOD FOR ILLUMINATING A SCENE

(71) Applicant: TRUMPF Photonic Components GmbH, Ulm (DE)

(72) Inventor: Stephan Gronenborn, Aachen (DE)

(21) Appl. No.: 18/749,663

(22) Filed: Jun. 21, 2024

Related U.S. Application Data
(63) Continuation of application No. PCT/EP2022/086128, filed on Dec. 15, 2022.

(30) Foreign Application Priority Data
Dec. 21, 2021 (DE) 10 2021 134 130.2

(51) Int. Cl. H04N 23/56; G01S 17/894; H04N 23/55; H04N 23/75

(52) U.S. Cl. CPC H04N 23/56; H04N 23/55; H04N 23/75; G01S 17/894

(57) ABSTRACT

An illumination device for illuminating a scene includes an array of light sources configured to emit respective light beams, a first optical unit, and a second optical unit. the first optical unit receives the light beams emitted by the light sources and directs the light beams onto the second optical unit. The first optical unit includes an imaging optical unit configured to project the light beams into the scene as spots in order to illuminate the scene with a spot pattern. The second optical unit includes an expanding optical unit configured to partly expand the light beams in order, with an expanded proportion of the light beams, to illuminate the scene simultaneously with the spot pattern with a substantially homogeneous illumination profile. The expanded proportion of the light beams amounts to less than 90% of a light intensity of the light beams emitted by the light sources.

### CROSS REFERENCE TO RELATED APPLICATIONS

This application is a continuation of International Application No. PCT/EP2022/086128 (WO 2023/117679 A1), filed on Dec. 15, 2022, and claims benefit to German Patent Application No. DE 10 2021 134 130.2, filed on Dec. 21, 2021. The aforementioned applications are hereby incorporated by reference herein.

### FIELD

Embodiments of the present invention relate to an illumination device for illuminating a scene, to a camera system in which such an illumination device is used, and to a method for illuminating a scene.

### BACKGROUND

Modern cameras used for distance measurement, object recognition or gesture recognition, for example, require specific illumination profiles. Recording a two-dimensional (2D) camera image of the scene, for example of an object, using a camera, for example a standard camera, requires flood illumination which is as homogeneous as possible and which illuminates the scene with as uniform illuminance as possible. If the camera is used as a three-dimensional (3D) sensor, illumination with a structured light pattern is required, wherein a depth image of the illuminated scene can be obtained by triangulation.

An illumination device of the type mentioned in the introduction can also be used with a time-of-flight (TOF) camera. With flood illumination, the full resolution of the camera can be utilized, but only for limited distances since the total power of the illumination device needs to be adapted so as to conform to eye safety demanded for laser light sources. The use of a structured light pattern, also called spot pattern, concentrates the eye-safe energy on a small number of pixels, whereby the signal-to-noise ratio on these pixels is increased and longer measurement distances are thus made possible, although at the expense of a lower resolution. If both illumination profiles can be generated by the illumination device, i.e. homogeneous flood illumination and spot illumination, the TOF camera can measure at different measurement distances. If only one of the two illumination profiles is provided, this limits either the measurement distance or the resolution.

These specific combinations of functions in one and the same camera necessitate either two different light sources that are individually controlled, or one light source switchable between flood illumination and spot illumination. One such illumination device is described in the document CN 108332082 A. This illumination device combines the two functions of flood illumination and spot illumination, wherein the illumination device has to be switched between flood illumination and spot illumination. The illumination device has a light source for emitting a light beam, a lens for diverging or converging the light beam, a diffractive optical element for expanding and directing the light beam onto the scene to be illuminated, and a processor in order to control the light beam. In one exemplary embodiment, the lens is a zoom lens, wherein the processor is used to vary the focal length of the lens in order to achieve flood illumination or spot illumination. In further exemplary embodiments, the diffractive optical element has a first diffraction pattern and a second diffraction pattern, wherein the angle between adjacent diffracted light beams is not greater than the aperture angle of the incident light beam, in order to realize flood illumination. The angle between adjacent diffracted light beams which are diffracted by the second diffraction pattern is greater than the aperture angle of the incident light beam, in order to realize illumination with structured light. The light source comprises a first partial light source and a second partial light source, wherein the processor controls the first partial light source in order to emit a first partial light beam, and the first partial light beam is replicated and expanded by the diffractive optical element in order to attain flood illumination. A setting device controls the second partial light source in order to emit a second partial light beam, and the second partial light beam is copied and expanded by the diffractive optical element in order to realize illumination with the spot pattern. The first partial light source and the second partial light source have different properties with regard to the light-emitting area, the aperture angle and/or the quantity of light. This known illumination device is therefore structurally complex and thus also costly since either movable optical elements, different light sources, diffractive optical elements with different diffraction patterns and/or a light beam controller are/is required for the two different illumination profiles of flood illumination and spot illumination.

### SUMMARY

Embodiments of the present invention provide an illumination device for illuminating a scene. The illumination device includes an array of light sources configured to emit respective light beams, a first optical unit, and a second optical unit. the first optical unit receives the light beams emitted by the light sources and directs the light beams onto the second optical unit. The first optical unit includes an imaging optical unit configured to project the light beams into the scene as spots in order to illuminate the scene with a spot pattern. The second optical unit includes an expanding optical unit configured to partly expand the light beams in order, with an expanded proportion of the light beams, to illuminate the scene simultaneously with the spot pattern with a substantially homogeneous illumination profile. The expanded proportion of the light beams amounts to less than 90% of a light intensity of the light beams emitted by the light sources.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic diagram of an illumination device having an array of light sources and a first optical unit according to some embodiments;

FIG. 2 shows a schematic diagram of the illumination device in FIG. 1, additionally with a second optical unit according to some embodiments;

FIG. 3 shows a schematic diagram of the illumination device in FIG. 1 for elucidating angular distance between light beams emitted by the light source and their aperture angle, according to some embodiments;

FIG. 4 shows a schematic diagram of the illumination device in FIG. 2, wherein the second optical unit is a diffractive optical unit, according to some embodiments;

FIG. 5A and FIG. 5B show a plan view and a side view of a second optical unit that is a refractive optical unit, according to some embodiments;

FIG. 6 shows a schematic diagram of an illumination device used to illuminate a scene simultaneously with a spot pattern and with a substantially homogeneous illumination profile, according to some embodiments;

FIG. 7 shows a frontal view of an illumination profile according to some embodiments;

FIG. 8 shows a schematic diagram of a camera system comprising a camera and an illumination device according to some embodiments; and

FIG. 9 shows a flow diagram of a method for illuminating a scene according to some embodiments.

### DETAILED DESCRIPTION

Embodiments of the present invention provide an illumination device which can simultaneously provide flood illumination and spot illumination for illuminating a scene and which in this case is structurally less complex and less costly.

Embodiments of the present invention also provide a camera system comprising such an illumination device, and a method for illuminating a scene.

According to some embodiments, an illumination device for illuminating a scene, comprising an array of light sources designed to emit respective light beams, furthermore comprising a first optical unit and a second optical unit, wherein the first optical unit receives the light beams emitted by the light sources and directs them onto the second optical unit, wherein the first optical unit is an imaging optical unit, which projects the individual light beams into the scene as spots in order to illuminate the scene with a spot pattern, and the second optical unit is an expanding optical unit, which partly expands the individual light beams in order, with the expanded proportion of the light beams, to illuminate the scene simultaneously with the spot pattern with a substantially homogeneous illumination profile, wherein the expanded proportion of the light beams amounts to less than 90% of the light intensity of the light beams emitted by the light sources.

The lighting device according to embodiments of the invention generates an illumination profile in the scene to be illuminated which is the sum of substantially homogeneous flood illumination and spot illumination. Flood illumination and spot illumination are simultaneously generated and directed into the scene, without this requiring a specific control of the light sources, or light sources having different properties, or movable controlled or switchable optical units. The way in which the illumination profile with the simultaneous flood illumination and spot illumination is utilized by the camera will also be described later on the basis of a camera system according to embodiments of the invention.

The first optical unit of the illumination device is an imaging optical unit, which images the light sources into the scene to be illuminated, which is tantamount to the individual light beams being projected into the scene as a spot. The first optical unit can be a converging single lens, for example, although the first optical unit can also have a plurality of lenses. The second optical unit disposed downstream of the first optical unit serves for generating the flood illumination which fills the spaces between the individual spots in the scene as uniformly as possible with light intensity. The uniform light intensity between the spots is lower than the intensity of the spots. For this purpose, the second optical unit spatially distributes only a proportion of the light energy contained in the light beams over the scene. The second optical unit can be configured as a diffusive, refractive or diffractive optical unit, which partly expands the individual light beams coming from the first optical unit. However, rather than the entire light intensity of the light beam being expanded, as is the case or is desired for standard diffusers, for example, only a proportion of the light intensity of the light beams is expanded, with the result that, firstly, pronounced spot illumination with higher irradiance in the spots and, secondly, a substantially homogeneous irradiance with lower irradiance between the spots can be realized.

The second optical unit can be for example a transmissive or reflective diffracting element, for example a diffractive beam splitter. In principle, all types of diffractive elements are suitable for use in the illumination device according to embodiments of the invention. The second optical unit can also be a refractive optical unit, for example a scattering element formed from a microlens array, or a diffusive optical unit, for example a scattering element.

The array of light sources can be in particular a two-dimensional array of light sources. The light sources can be laser diodes, in particular vertical cavity surface emitting lasers (VCSELs). The light beam emitted by a VCSEL typically has a circular cross section in the far field, and the full aperture angle of the light beam emitted by a VCSEL is typically small, for example less than 20°.

At least the first optical unit can be integrated in the array of light sources. By way of example, the light sources can be VCSELs, wherein the first optical unit in the case of lasers emitting on the substrate side can be integrated in the wafer or in the substrate on which the VCSELs are arranged. The second optical unit can be configured integrally with the first optical unit.

Preferably, the proportion of the light intensity of the light beams that is expanded by the second optical unit amounts to less than 80%, preferably less than 70%, with further preference less than 60%, with further preference less than 50%, of the light intensity of the light beams emitted by the light sources.

The smaller the proportion of the light energy of the light beams that is deflected or expanded from the light beams, the greater the light intensity that remains in the spot illumination, which has the advantage that the measurement distance with a 3D camera, for example a TOF camera, is increased. This is useful particularly for the 3D capture of objects far away. Conversely, the greater the light intensity that is diverted or expanded from the light beams, the “brighter” the flood illumination, whereby a well-illuminated 2D image of the scene can be recorded for example in the case of a camera used as a 2D camera.

With further preference, the second optical unit expands the light beams with a maximum expansion angle which is equal to an angular distance, or an integral multiple thereof, between two light beams minus an aperture angle of a light beam.

This configuration differs from standard expansion optical units, for example diffusers, which scatter all the light beams from the array of light sources into the entire scene.

In this case, the two light beams mentioned above are preferably directly adjacent light beams.

In this configuration, the expansion angle with which the second optical unit distributes a proportion of the light energy among the spots can be limited to the space between the individual light beams. The smallest maximum expansion angle of the individual light beams is thus achieved.

If the second optical unit is a diffractive optical unit, the diffractive optical unit is preferably configured in such a way that the angle between intensity maxima of adjacent orders of diffraction substantially corresponds to the aperture angle of a light beam, divided by an integer greater than or equal to 1.

In this configuration, the diffractive optical unit fans out the individual light beams into the individual orders of diffraction in such a way that the individual orders of diffraction directly adjoin one another or even overlap. The aperture angle here is the full aperture angle of a light beam.

In this context, it is furthermore preferred if the light intensity at the output of the diffractive optical unit in the respective zeroth order of diffraction is at least 50%, preferably at least 100%, preferably at least 150%, with further preference at least 200%, greater than in the order of diffraction with the second highest light intensity.

This configuration is a special feature for diffractive optical units since diffractive optical units are usually configured in such a way that the zeroth order of diffraction is suppressed to the greatest possible extent. According to some embodiments, the configuration mentioned is preferred because the zeroth order of diffraction corresponds to the direction of propagation of the proportion of the intensity of the light beams for the formation of the spot pattern. As a result, the spot pattern arises in the scene with sufficiently high irradiance, while the flood illumination is generated by the first and higher orders of diffraction.

If the second optical unit is a refractive optical unit having an array of microlenses, a fill factor of the lenses in the array is less than 100%, preferably less than 90%, with further preference less than 80%, with further preference less than 70%, with further preference less than 60%, with further preference less than 50%.

This configuration differs from refractive expanding optical units which are formed by microlens arrays and which are used with an array of VCSELs. In the case of typical refractive expanding optical units based on microlenses, the aim is always to bring the fill factor of the lenses as far as possible to 100%, in order to avoid a direct, non-deflected transmission by the optical unit. According to some embodiments, it is preferred to configure the refractive optical unit with a lower fill factor in such a way that a significant proportion of the light energy is not deflected. This can be achieved in a very simple configuration of the microlens array in practice by flat or planar regions being integrated in the microlens array, for example within each lens, between the lenses, or by a portion of the lenses being replaced with a flat or planar region. The flat regions should be large enough to minimize diffraction at openings formed by the edges of flat regions. The flat regions should therefore have dimensions of the order of magnitude of a plurality of wavelengths of the light emitted by the light sources.

Embodiments of the present invention further provide a camera system, comprising a camera having an image sensor, and comprising an illumination device according to one or more of the configurations mentioned above, wherein first pixels of the image sensor record the part of the scene illuminated with the substantially homogeneous illumination profile and second pixels record the spot pattern projected into the scene.

The majority of the pixels of the image sensor “see” that part of the scene which is illuminated with the homogeneous floodlight with lower irradiance, while a smaller proportion of the pixels “see” the smaller regions of the scene which are illuminated by the spots with high irradiance.

Preferably, the camera system has a camera controller designed to set the exposure time of the image sensor, wherein the camera controller is designed to set a first exposure time in order, with the first pixels of the image sensor, to record the scene with the substantially homogeneous illumination profile, and a second exposure time, which is shorter than the first exposure time, in order, with the second pixels of the image sensor, to record the scene with the spot pattern projected into the scene.

If the image sensor is used with the first, long or longer, exposure time, the first pixels will generate a sufficient sensor signal which enables a measurement, while the second pixels are overexposed and are excluded from the measurement. The camera can then be used with the short or shorter exposure time, wherein the first pixels then generate substantially no signal or a signal that is too weak and are excluded from the measurement. By contrast, the second pixels generate a sufficient signal strength and allow a measurement at longer distances, for example. The two measurements can then be combined into a complete image of the scene.

If the camera is a standard camera, for example, it is preferred if the camera controller is designed to record a 2D image of the scene from signal values of the first pixels, and to determine 3D information about the scene from signal values of the second pixels by means of triangulation. As described above, the 2D image is recorded with a long exposure time, and the 3D information is recorded with a short exposure time.

With further preference, in this case, the camera controller is designed to at least partly replace the signal values obtained by the second pixels during the first (long or longer) exposure time with signal values obtained by the second pixels during the second (short or shorter) exposure time.

In this way, it is possible to obtain a full 2D grayscale image and additionally the 3D information for the positions of the spots in the spot pattern and the scene.

The abovementioned replacement of the signal values of the second pixels can be weighted with the exposure time and the relative irradiance.

If the camera is a time-of-flight camera (TOF camera), the camera controller is preferably designed to obtain a first 3D partial image of the scene from signal values of the first pixels and a second 3D partial image of the scene from signal values of the second pixels, wherein the camera controller is designed to combine the two 3D partial images to form a complete 3D image of the scene.

In the case of a TOF camera used to record or measure an object at a small distance, the long exposure time produces a 3D image for the first pixels, while the second pixels are overexposed. The image recorded during the short exposure time produces the 3D partial image only for the second pixels, since the first pixels generate a signal that is too weak. Combining the two partial images yields a 3D image with full resolution similar to a TOF camera operating only with flood illumination. However, if an object to be observed is far away or has a high level of absorption or low reflection, the second pixels, at least during the long exposure time, still produce a sufficient signal, which makes it possible to obtain a 3D image which has a lower resolution but still yields 3D information even in the case of large measurement distances or objects which reflect only little light back to the camera.

Embodiments of the present invention further provide a method for illuminating a scene, comprising the following steps:
emitting, by means of an array of light sources, individual light beams,
projecting, by means of a first optical unit, the light beams as spots into the scene in order to illuminate the scene with a spot pattern,
simultaneously with projecting the light beams as spots, partly expanding, by means of a second optical unit, the light beams in order, with the expanded proportion of the light beams, to illuminate the scene together with the spot pattern with a substantially homogeneous illumination profile, wherein the expanded proportion of the light beams amounts to less than 90% of the total intensity of the light beams.

It goes without saying that the abovementioned features and the features yet to be explained below are usable not only in the respectively specified combination but also in other combinations or on their own, without departing from the scope of the present invention.

In the figures, identical or comparable elements are provided with the same reference signs throughout.

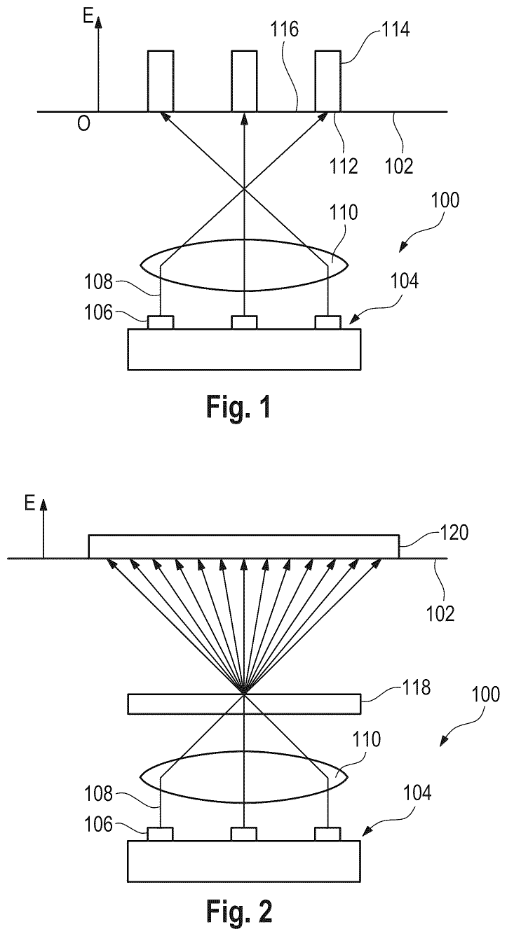

Referring to FIGS. 1 and 2, firstly two illumination devices are described which can be used to illuminate a scene either only with a spot pattern or only with a substantially homogeneous illumination profile without a spot pattern.

FIG. 1 shows an illumination device 100 for illuminating a scene 102. The illumination device 100 has an array 104 of light sources 106. Three light sources 106 are shown by way of example in the schematic drawing in FIG. 1. It goes without saying, however, that the array 104 can have a large number of light sources 106, for example 100 or more light sources 106. The light sources 106 can be distributed in particular in a two-dimensional arrangement. The light sources 106, and the same applies to the configuration of an illumination device according to embodiments of the invention that will also be described later, can be laser diodes, in particular vertical cavity surface emitting lasers (VCSELs). The light emitted by the light sources can be in the visible and/or near infrared or infrared spectral range. Each light source 106 emits a light beam 108, the light beams 108 each being represented by a line in FIG. 1.

The illumination device 100 furthermore has a first optical unit 110. The optical unit 110 is an imaging optical unit, which projects the individual light beams 108 into the scene 102 as spots 112. In other words, the first optical unit 110 images the light sources 106 into the scene 102.

In FIG. 1, the irradiance E along the scene 102 is illustrated in an upper diagram. Substantially the entire energy of the light emitted by the light sources 106 is contained in the spot pattern, and the irradiance E in the region of the spots 112 is correspondingly high. No or virtually no light energy is present in regions 116 between the spots 112. With an illumination profile that illuminates the scene 102 with individual separated spots 112, a 3D image can be recorded by means of a camera, even when there are relatively large distances between the scene 102 and the camera, but with a low resolution.

FIG. 2 shows the illumination device 100 from FIG. 1, wherein now a second optical unit 118 is additionally present, wherein the first optical unit 110 directs the light beams 108 onto the second optical unit 118. In the example in FIG. 2, the first optical unit 110 can also be absent. The second optical unit 118 is an expanding optical unit, which uniformly scatters the entire light energy contained in the light beams 108 into the entire scene to be observed, with the result that the scene 102 is illuminated with a homogeneous illumination profile 120, as is illustrated in the upper diagram in FIG. 2. As revealed by a comparison of FIG. 2 with FIG. 1, the irradiance E (power of the incoming electromagnetic energy which impinges on a surface relative to the size of the surface area) in the scene 102 is substantially homogeneous, but lower than in the individual spots 112 in accordance with FIG. 1. With a homogeneous illumination profile 120 as illustrated in FIG. 2, a 2D image can be recorded by means of a camera.

If a standard camera is intended to be used as a camera for recording both 2D images and 3D images, for example, both illumination profiles, i.e. both the spot pattern in accordance with FIG. 1 and the substantially homogeneous illumination profile in accordance with FIG. 2, are required. This can be realized by the illumination device 100 being switched between the two kinds of illumination, for example by the second optical unit 118 being alternately introduced into the beam path and removed again therefrom. However, this is associated with additional structural complexity. A description is given below of how it can be made possible that the scene 102 can be simultaneously illuminated with a spot pattern in accordance with FIG. 1 and a substantially homogeneous illumination profile in accordance with FIG. 2, without the need for switching over the device, movable optical elements or different light sources 106 in the array 104.

In principle, this is realized according to embodiments of the invention by the individual light beams being partly expanded, i.e. a proportion of the light energy contained in the light beams being spatially distributed or fanned out, in particular refracted, scattered or diffracted, with the result that, firstly, a pronounced spot pattern is maintained and, secondly, the regions in the scene between the spots 112 are illuminated with a sufficient irradiance.

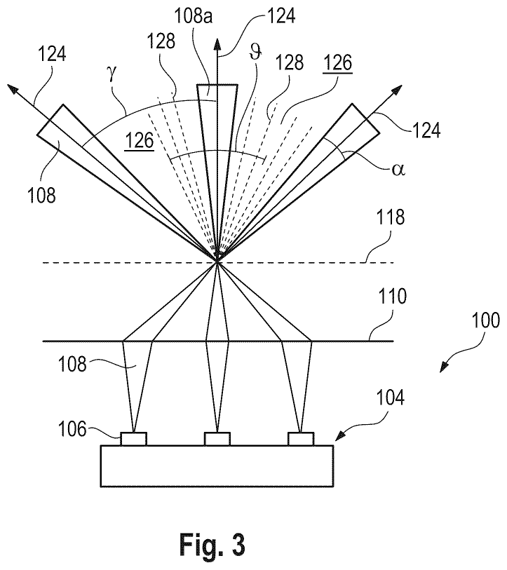

FIG. 3 shows the illumination device 100 in accordance with FIG. 1 again, wherein the first optical unit 110 is illustrated just as a line, for simplification. In FIG. 3, the light beams 108 are shown with their aperture angle given by the type of light sources 106. In the case of VCSELs as light sources 106, the natural aperture or divergence angle is a few degrees, for example in a range of approximately 12° to 15°. The first optical unit 110 converges the individual light beams 108, which propagate downstream of the first optical unit 110 with an aperture angle α, also referred to as spot size angle. The individual light beams 108 are separated from one another by an angular distance γ. While FIG. 3 is only a two-dimensional representation, it is understood that the aperture angle α is taken in two mutually perpendicular directions and the angular distance γ in the case of a two-dimensional array 104 is likewise taken in two mutually perpendicular directions, wherein the aperture angle α and/or the angular distance γ can be different in the two mutually perpendicular directions.

In order to generate an illumination profile in the scene 102 which is simultaneously or in total a spot pattern in accordance with FIG. 1 and a substantially homogeneous illumination profile in accordance with FIG. 2, the second optical unit 118 is configured in such a way that when it receives the light beams 108 from the first optical unit 110, it deflects only a proportion of less than 90% of the intensity of the individual light beams 108 from the direction of propagation thereof, which are illustrated by arrows 124 in FIG. 3, into the respective interspace between the light beams 108. Preferably, the deflected proportion of the light intensity of the light beams is less than 80%, preferably less than 70%, with further preference less than 60%, with further preference less than 50%, of the light intensity of the light beams 108 emitted by the light sources 106. The second optical unit 118 only has to expand one proportion of the light intensity of each of the light beams with a maximum expansion angle 9 which is substantially equal to or greater than the angular distance γ between two light sources 108. It generally holds true that, independently of the type of second optical unit, preferably δ≥γ·i, where i is an integer greater than or equal to 1. The expansion angle 9 relates to the full width at half maximum (FWHM) of the intensity of a light beam 108 that is expanded by the second optical unit. The proportion of the intensity of an exemplary light beam 108a that is expanded or spread by the second optical unit 118 is illustrated using interrupted lines 128 in FIG. 3. The maximum angle δ can be minimized if the angle γ is taken between two directly adjacent light beams 108.

This will be explained on the basis of an example. It is assumed that the field of view of a camera is 60° x 45°, and this field of view is intended to be filled with 20×15 spots with an aperture angle of a spot (spot size angle) α of 0.5°. The angular distance γ between directly adjacent spots is then 3° in both mutually perpendicular directions (60°/20 spots=3° and 45°/15 spots=) 3°. The second optical unit 118 can then have a two-dimensional expansion pattern with 3° full aperture angle at half intensity maximum, or a multiple thereof for an improved homogeneity.

In order to achieve this, the second optical unit 118 can be a diffusive, refractive or diffractive optical unit.

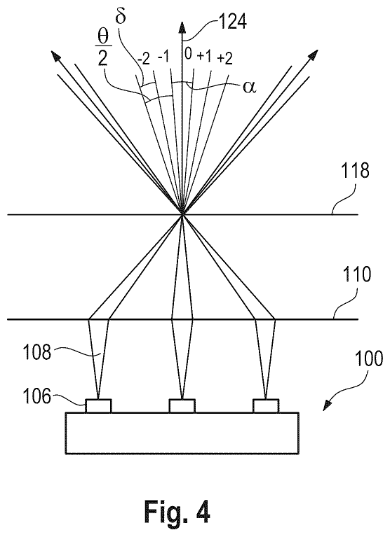

FIG. 4 shows the case where the second optical unit 118 is a diffractive optical unit, for example a diffractive beam splitter, which splits the individual light beams 108 into a plurality of light beams by diffraction. The diffractive optical unit generates preferably N defined diffracted beams in N orders of diffraction (excluding the zeroth order of diffraction) with as far as possible the same intensity, and preferably has a defined maximum order of diffraction or a defined maximum diffraction angle θ, while the light intensity beyond the maximum order of diffraction preferably falls rapidly. In the example in FIG. 4, the maximum order of diffraction is +2 and −2, and N is thus 4. The maximum diffraction angle θ is then the full angle between the maximum orders of diffraction. The maximum diffraction angle can be the angular distance γ between adjacent light beams 108 minus the aperture or spot size angle α, where in particular θ=γ·i−α can hold true, where i is an integer. The expansion angle δ preferably results as δ=θ+α. A maximum angle & between the different orders of diffraction is preferably of the order of magnitude of the aperture angle or spot size angle α, which is 0.5° in the example mentioned above, with the result that the individual diffracted images of the spots directly adjoin one another or even overlap. The maximum angle δ between the orders of diffraction can also be smaller, in such a way that the images of the individual spots overlap one another. Very good results are achieved if the maximum angle δ between the orders of diffraction corresponds to the aperture angle (spot size angle) a divided by an integer, i.e. δ=α/j, where j is an integer.

The second optical unit 118 can also be a refractive or diffusive optical unit, which, in the example mentioned above, expands the respective light beams with an expansion angle of 3° in both mutually perpendicular directions.

Both in the case of a diffractive optical unit and in the case of a refractive or diffusive optical unit, the second optical unit 118 is preferably configured in such a way that a significant proportion of the light intensity of each light beam 108 is not diffracted and not scattered. In other words, in the case of a diffractive optical unit as second optical unit 118, the latter is configured in such a way that the light intensity at the output of the diffractive optical unit in the zeroth order of diffraction is at least 50% greater than in the order of diffraction with the second highest light intensity. Preferably, the light intensity at the output of the diffractive optical unit in the respective zeroth order of diffraction is at least 100%, preferably at least 150%, with further preference at least 200%, greater than in the order of diffraction with the second highest light intensity. A similar situation holds true for the case where the second optical unit 118 is a diffusive optical unit. In this case, too, it is preferred if the non-deflected intensity at the output of the diffusive optical unit of the orders of magnitude mentioned above is greater than in the scattered directions.

A diffractive optical unit can be configured as a transmissive or reflective diffractive optical unit. The diffractive optical unit can be configured as a line grating, a perforated grating, an echelle grating, a hologram grating, etc., provided that the diffractive optical unit, as described above, diffracts a proportion of the light intensity of less than 90% from the light beams into the first, second and further orders of diffraction.

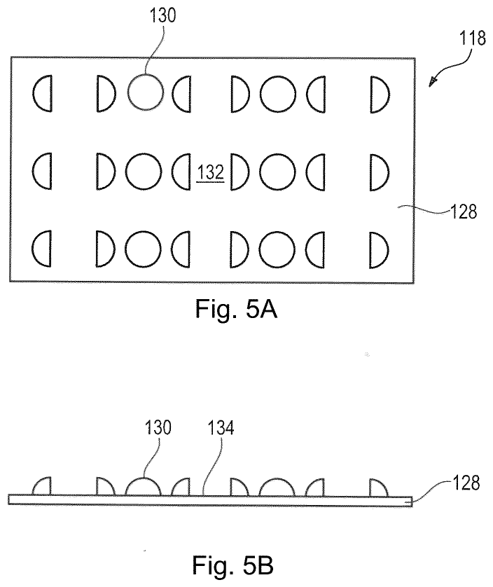

FIGS. 5a) and b) show a second optical unit 118 configured as a refractive optical unit. In this example, the second optical unit 118 is configured as an array 128 of microlenses 130. In contrast to typical microlens-based expanding optical units, where there is a desire to bring the fill factor of the lenses to close to 100% in order to avoid scattering losses and in particular a direct, non-deflected transmission by the optical unit, in the case of the array 128 of microlenses 130 provision is made for specific regions 132 of the array 128 not to deflect or scatter the respective light beam, with the result that a significant proportion of the light energy is not expanded. Preferably, the fill factor of the lenses in the array is less than 90%, with further preference less than 80%, with further preference less than 70%, with further preference less than 60%, with further preference less than 50%. FIGS. 5a) and b) show, as a simple example, that flat regions 134 are integrated in the array for example within some or all lenses or between the lenses. Non-expanding regions can also be realized by some of the lenses being omitted in order thus to achieve a fill factor of lenses in the array of significantly less than 100%, for example 50%. The flat regions 134 should be large enough to minimize diffraction losses caused by edges. In other words, apertures created by the flat regions should have a size of the order of magnitude of a plurality of wavelengths of the light emitted by the light sources.

A diffusive optical unit as the second optical unit 118 can be a diffusing plate, for example a plate with a rough surface, or a milk glass, wherein here, too, there are regions that have no scattering effect in order not to scatter a significant proportion of the intensity of the light beams 108, in order to maintain a pronounced spot pattern in the illumination profile.

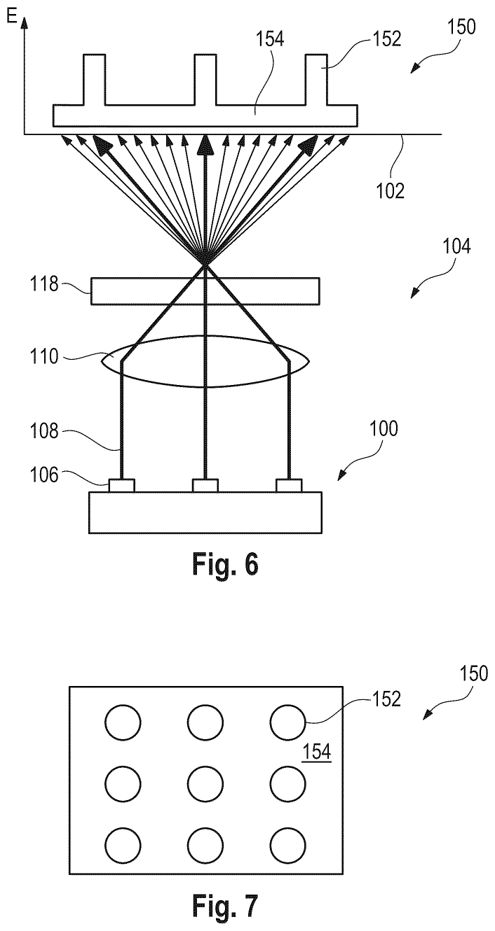

FIG. 6 shows an illumination device 100 that intrinsically combines the aspects described above. The illumination device 100 has the array 104 of light sources 106, each of which emits a light beam 108. The light beams 108 are projected into the scene 102 by the imaging first optical unit 110. The second optical unit 118 receives the light beams 108 from the first optical unit 110 and expands a proportion of less than 90% of the light intensity of the individual light beams 108. The second optical unit 118 is configured as described above, for example as a diffractive, refractive or diffusive optical unit having the properties described above. The illumination profile 150 that results in the scene 102 simultaneously contains a spot pattern of spots 152 and simultaneously therewith a substantially homogeneous illumination profile 154. In other words, the illumination profile 150 is the sum of the spot pattern 152 and the substantially homogeneous illumination profile 154. The individual spots 152 have a greater intensity or irradiance E in the scene 102 than the substantially homogeneous illumination profile 154. The advantage of the illumination device 100 is that the light sources 106 do not have to be different or be operated differently among one another, nor do optical units such as the first optical unit 110 and/or the second optical unit 118 have to be displaced or brought into or out of the beam path.

FIG. 7 shows the illumination profile 150 in a frontal view with the spots 152 and the substantially homogeneous illumination profile 154.

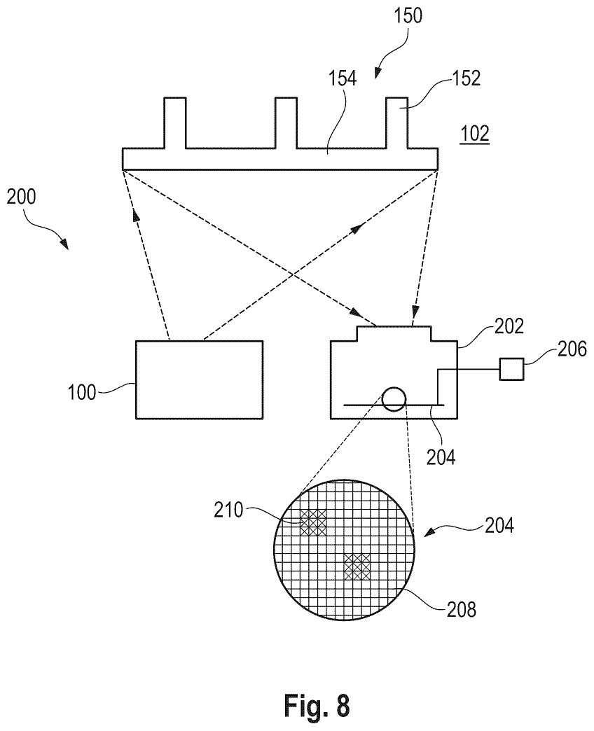

FIG. 8 shows a camera system 200 having the illumination device 100 according to one or more of the embodiments described above, and having a camera 202. The illumination device 100 illuminates the scene 102 with the illumination profile 150 which simultaneously contains a spot pattern of spots 152 and a substantially homogeneous illumination profile 154 with a lower illuminance than the spot pattern, as has been described above.

The camera 202 has an image sensor 204. FIG. 8 shows an enlarged detail from the image sensor 204 in plan view. The camera 202 furthermore has a camera controller 206.

The camera 202 records the scene 102 illuminated with the illumination profile 150. In this case, first pixels 208 of the image sensor 204, which are not hatched in the enlarged detail in FIG. 8, see the larger part of the scene illuminated with the substantially homogeneous illumination profile 154. By contrast, second pixels 210, which are hatched in the enlarged detail from the image sensor 204 in FIG. 8, see the smaller part of the scene, into which the spot pattern with the spots 152 is projected.

The camera controller 206 is designed to set the exposure time of the image sensor 204. In this case, the camera controller 206 is designed to set a first exposure time T₁ in order, with the first pixels 208 of the image sensor 204, to record the scene 102 with the substantially homogeneous illumination profile 154. The camera controller 206 is furthermore designed to set a second exposure time T₂, which is shorter than the first exposure time T₁, in order, with the second pixels 210 of the image sensor 204, to record the scene 102 with the spot pattern with the spots 152 that is projected into the scene.

When the first (longer) exposure time T₁ is set, the first pixels 208 will provide a sensor signal which is sufficient with regard to the signal-to-noise ratio and which enables a measurement, while the second pixels 210 will be overexposed and are excluded from the measurement. The camera can then be used with the second (shorter) exposure time T₂, wherein the first pixels 208 then generate no image signal or an image signal that is too weak, since the substantially homogeneous illumination profile 154 has a comparatively low irradiance E. Consequently, the first pixels 208 do not contribute to the measurement and are excluded therefrom. The second pixels 210 produce a good signal strength during the short exposure time T₂ and allow a measurement even at relatively large distances from the scene 102. Both measurements, i.e. the measurement during the short exposure time and the measurement during the long exposure time, can then be combined into a complete image of the scene 102.

The camera 202 can be for example a standard camera or a time-of-flight (TOF) camera.

In the case where the camera 202 is a standard camera, with the shorter exposure time T₂ being set, the part of the scene 202 that is illuminated with the spot pattern can be recorded by the camera 202, in which case the camera controller then determines 3D information about the scene 102 from the signal values of the second pixels 210 by means of triangulation, i.e. can record a depth image of the scene with a resolution corresponding to the density of the spots in the scene 102. When the longer exposure time is set, a conventional 2D image can be recorded by the camera 202 by means of the first pixels 208, while the second pixels 210 are overexposed. In a processing step, the signal values of the second pixels 210 can be replaced with the signal values of the second pixels during the short exposure time T₂, wherein the replacement can optionally be weighted with the exposure time and the relative irradiance. Overall, it is possible to obtain a full two-dimensional image, for example a grayscale image, and additionally the three-dimensional information for the positions of the spots 152 in the spot pattern of the illumination profile 150.

If the camera 202 is a time-of-flight (TOF) camera, it is possible to record a scene 102 located near the camera 202, for example an object in the vicinity of the camera. When the long exposure time T₁ is set, a 3D partial image is generated by the first pixels 208, while the second pixels 210 are overexposed and are excluded from the measurement. During the short exposure time T₂, a 3D partial image arises only from the signal values of the second pixels, since the signal values of the first pixels 208 are too low. Combining the two 3D partial images yields a full resolution 3D image. In contrast to a TOF camera operated with an illumination device that provides only flood illumination, the camera system according to embodiments of the invention can however also record a scene 102 located far away, for example an object situated far from the camera 202, or an object having a high level of absorption or low reflection, since the second pixels 210 still yield a good signal, at least when the longer exposure time T₁ is set. This means that even with relatively large measurement distances or when recording scenes which reflect back only little illumination light, the camera system according to embodiments of the invention makes it possible to obtain at least one 3D partial image, albeit with lower resolution. This is a significant difference vis-à-vis the conventional case where the TOF camera is operated with an illumination device that provides only flood illumination.

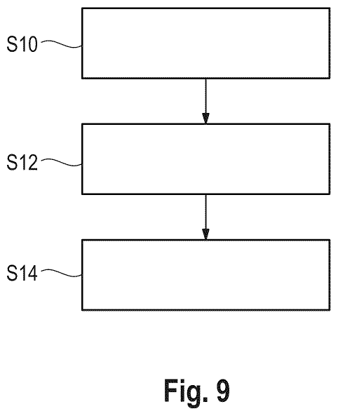

FIG. 9 shows a flow diagram of a method for illuminating a scene. The method comprises a step S10, according to which individual light beams 108 are emitted by means of the array 104 of light sources 106.

In a step S12, by means of the first optical unit 110, the light beams 108 are projected as spots 152 into the scene 102 in order to illuminate the scene 102 with a spot pattern.

In a step S14, simultaneously with projecting the light beams 108 as spots 152, by means of a second optical unit, the light beams 108 are partly expanded, in particular scattered or diffracted, in order, with the scattered or diffracted proportion of the light intensity of the light beams 108, to illuminate the scene together with the spot pattern 152 with a substantially homogeneous illumination profile 154. In this case, the scattered or diffracted proportion of the light intensity of the light beams 108 amounts to less than 90% of the total intensity of the light beams 108.

The method thus makes it possible to generate an illumination profile 150 as shown in FIG. 6.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An illumination device for illuminating a scene, the illumination device comprising:
an array of light sources configured to emit respective light beams,
a first optical unit, and
a second optical unit,
wherein the first optical unit receives the light beams emitted by the light sources and directs the light beams onto the second optical unit,
wherein the first optical unit comprises an imaging optical unit configured to project the light beams into the scene as spots in order to illuminate the scene with a spot pattern, and the second optical unit comprises an expanding optical unit configured to partly expand the light beams in order, with an expanded proportion of the light beams, to illuminate the scene simultaneously with the spot pattern with a substantially homogeneous illumination profile,
wherein the expanded proportion of the light beams amounts to less than 90% of a light intensity of the light beams emitted by the light sources.

2. The illumination device as claimed in claim 1, wherein the expanded proportion of the light beams amounts to less than 50% of the light intensity of the light beams emitted by the light sources.

3. The illumination device as claimed in claim 1, wherein the second optical unit expands the light beams with an expansion angle that is equal to an angular distance, or an integral multiple thereof, between two light beams.

4. The illumination device as claimed in claim 3, wherein the two light beams are directly adjacent light beams.

5. The illumination device as claimed in claim 1, wherein the second optical unit is a diffractive, refractive or diffusive optical unit.

6. The illumination device as claimed in claim 1, wherein the second optical unit is a diffractive optical unit configured in such a way that an angle between intensity maxima of adjacent orders of diffraction substantially corresponds to an aperture angle of each light beam, divided by an integer greater than or equal to 1.

7. The illumination device as claimed in claim 1, wherein the second optical unit is a diffractive optical unit that diffracts each individual light beam with a maximum diffraction angle that is equal to an angular distance, or an integral multiple thereof, between two light beams minus an aperture angle of each light beam.

8. The illumination device as claimed in claim 1, wherein the second optical unit is a diffractive optical unit, and wherein a light intensity at an output of the diffractive optical unit in a respective zeroth order of diffraction is at least 50% greater than in an order of diffraction with a second highest light intensity.

9. The illumination device as claimed in claim 8, wherein the light intensity at the output of the diffractive optical unit in the respective zeroth order of diffraction is at least 150% greater than in the order of diffraction with the second highest light intensity.

10. The illumination device as claimed in claim 1, wherein the second optical unit is a refractive optical unit having an array of microlenses, wherein a fill factor of the microlenses in the array is less than 100%.

11. A camera system, comprising:
a camera having an image sensor,
an illumination device as claimed in claim 1,
wherein first pixels of the image sensor record a part of the scene illuminated with the substantially homogeneous illumination profile, and second pixels of the image sensor record the spot pattern projected into the scene.

12. The camera system as claimed in claim 11, furthermore comprising a camera controller configured to set exposure times of the image sensor, wherein the camera controller is configured to set a first exposure time in order, with the first pixels of the image sensor, to record the scene with the substantially homogeneous illumination profile, and to set a second exposure time, which is shorter than the first exposure time, in order, with the second pixels of the image sensor, to record the scene with the spot pattern projected into the scene.

13. The camera system as claimed in claim 11, wherein the camera controller is configured to record a 2D image of the scene from signal values of the first pixels, and to determine 3D information about the scene from signal values of the second pixels by triangulation.

14. The camera system as claimed in claim 12, wherein the camera controller is configured to at least partly replace signal values of the second pixels during the first exposure time with signal values of the second pixels during the second exposure time.

15. The camera system as claimed in claim 12, wherein the camera is a time-of-flight camera, and wherein the camera controller is configured to obtain a first 3D partial image of the scene from signal values of the first pixels and a second 3D partial image of the scene from signal values of the second pixels, wherein the camera controller is configured to combine the first 3D partial image and the second 3D partial image to form a 3D image of the scene.

16. A method for illuminating a scene, the method comprising:
emitting, by an array of light sources, individual light beams,
projecting, by a first optical unit, the light beams as spots into the scene in order to illuminate the scene with a spot pattern,
simultaneously with projecting the light beams as spots, partly expanding, by a second optical unit, the light beams in order, with an expanded proportion of the light beams, to illuminate the scene together with the spot pattern with a substantially homogeneous illumination profile, wherein the expanded proportion of the light beams amounts to less than 90% of a total intensity of the light beams.
